(19) United States
(12) Patent Application Publication
(10) Pub. No.: US 2026/0216684 A1
(43) Pub. Date: Jul. 30, 2026

(54) METHOD FOR GENERATING HIGH PURITY AND FINELY DISPERSED NANOPARTICLES BY INDUCTIVE LOCAL HEATING

(71) Applicant: THE CYPRUS INSTITUTE, Nicosia (CY)

(72) Inventor: George Biskos, Nicosia (CY)

(21) Appl. No.: 19/147,644

(22) PCT Filed: Jan. 13, 2023
(86) PCT No.: PCT/IB2023/050310

§ 371 Date: Jul. 11, 2025

(51) Int. Cl. B01J 19/08

(52) U.S. Cl. CPC B01J 19/087; B01J 2219/0869; B01J 2219/0871; B01J 2219/0879

(57) ABSTRACT

The objective of this document is to introduce a novel method for generating high-purity aerosol nanoparticles of well-defined size and chemical composition to use as building blocks in nanomaterial synthesis for various applications. The method employs inductive heating to produce metal vapors from a target electrode, which are subsequently carried away and cooled down by a gas stream to yield atomic clusters and nanoparticles (singlets and agglomerates) by nucleation and subsequent growth by condensation and coagulation. The novelty of the method relies on the fact that the only material in the heating zone is the target electrode, avoiding any holders which can unintentionally emit impurities upon heating either directly by the inductive heater or indirectly by the heated target electrode. This is highly advantageous as it ensures that only vapors from the target material are produced in the carrier gas, resulting in the formation of atomic clusters and subsequently nanoparticles of extremely high purity. Furthermore, the magnetic field produced by the inductor coil is focused on the tip of the electrode which is sharpened in a way that the carrier gas flowing around it does not become turbulent. The focused magnetic field ensures very local heating at, and thus emission of the metal vapors from, the tip of the electrode, whereas by maintaining flow laminarity around the electrode tip ensures that the resulting vapors downstream have the same history, and consequently yield particles of the same size (monodisperse).

### FIELD OF INVENTION

The present invention relates to a method for generating high-purity and finely dispersed aerosol nanoparticles, and more specifically to a method for generating aerosol nanoparticles having well-defined size and chemical composition for use as building blocks in nanomaterial synthesis for various applications.

In particular, the method employs an electromagnetic heater which supplies the heat locally to the target material in order to achieve the desired purity level of the generated atomic clusters and nanoparticles.

### BACKGROUND

Synthesizing nanoparticles of well-defined size and chemical composition is of paramount importance in the field of nanotechnology as they comprise the building blocks for any nanomaterial. The produced nanoparticles find numerous applications in such areas as electronics, biomedicine, textile production, etc.

Nanoparticles can be prepared by gas-phase synthesis methods through the cooling of a saturated dense gas under specific conditions, leading to atomic cluster and nanoparticle formation through nucleation and subsequent growth by condensation and agglomeration/coagulation.

In particular, the method of producing nanoparticles by gas phase synthesis has many advantages, including that it provides:
continuous production of the atomic clusters and nanoparticles,
good control over the size and composition of the atomic clusters and nanoparticles,
a highly reproducible production process,
high versatility of the techniques as it can produce nanoparticles of a wider range of compositions,
minimum or even absence of wastes, and
relatively low operating costs.

Different gas-phase synthesis techniques can produce aerosol nanoparticles, as for example:
1. electrohydrodynamic processes, as electro-spraying or atomization, which are used, for example, for fabricating protein-based nanoparticles and nanofibers and by which high-intensity electric fields are applied to liquid precursor solutions (i.e. protein solutions); the main advantage of this technique is that it can avoid any organic solvents and heat treatment;
2. flame technology, as flame aerosol synthesis of nanoparticle, which can be used to produce nanoparticles, as, for example, inorganic submicron particles with closely controlled morphology and composition;
3. evaporation-condensation techniques using heating or ablation, by which a vapor is produced from a target material by heating or laser ablation or spark discharge, which is subsequently carried away and cooled down by a gas stream to yield atomic clusters and nanoparticles.

Among these categories, the evaporation-condensation techniques hold important advantages that may have several industrial applications.

Moreover, the aerosol-based evaporation-condensation synthesis methods are highly attractive as they can produce nanoparticles of extremely high purity, and at the same time they are very environmentally friendly, because no by-product wastes are formed. These two features make in general the evaporation-condensation aerosol-based methods particularly attractive for industrial applications as reflected by the fact that a number of manufacturers in the field of nanotechnology (specifically nanoelectronics) already consider employing them.

Among the evaporation-condensation methods, the one involving a tube furnace reactor where vapors are produced from the target material and subsequently cooled down by a passing gas flow forming aerosol nanoparticles, is the least favorable to use, mainly because of the impurities introduced to the gas stream and consequently to the synthesized particles, as the entire tube furnace reactor, which includes the target material, has to be heated. Even inert materials, such as glass and ceramics, that are oftentimes employed in tube furnaces, have been shown to introduce impurities in the carrier gas and consequently to the resulting nanoparticles, comprising a main limitation for almost all applications in nanotechnology.

In this respect, ablation methods using sparks, arcs or lasers are capable of producing nanoparticles of higher purity as they only heat up the target material, from which nanoparticles are synthesized, and not the entire reactor.

The disadvantage of the ablation methods, however, is that they typically require sophisticated systems (e.g., high power lasers or circuits for producing sparks and arcs), which in turn increase their manufacturing cost.

A cost-effective alternative to ablation methods is to use target materials in the form of wires that are heated by passing a high current through them. Although this method has been used extensively for research purposes, it suffers from the fact that the production of the nanoparticles can interrupt as the wires brake easily and frequently when heated up.

In addition, because emission of the vapors from the wire is not localized, as they can be emitted from many points along the heated part of the wire, the particles in the resulting aerosol do not have the same history, and consequently are not monodisperse.

A novel alternative to using current to evaporate materials from a conducting target material is to use inductive heating. By this method, the target material is heated by an inductive heater while a particle-free stream flowing around the target material carries the resulting vapor away and cools it down forming nanoparticles that in principle have the same composition as the target material.

Compared to nanoparticle generators using electric heating, an Inductive Heating Nanoparticle Generator (IHNG) has the advantage that it cannot be interrupted, while at the same time by controlling the operating conditions (i.e., heating, and quenching flow rate) one can achieve a very stable nanoparticle synthesis process.

In the U.S. Pat. No. 8,362,407 B2 (Apparatus for particle synthesis, 2013), an induction heating element for heating the reactor wall is used as an example of a hot wall tube type reactor. In this case, inductive heating is used to heat the walls of the reactor, which in turn provide the heat for the particle/nanoparticle synthesis. As a result, the apparatus is in fact a tube furnace reactor where parts other than the target material are also heated up, leading to potential impurities on the resulting particles as described above. This provides an important limitation in the use of that apparatus for nanomaterial synthesis.

According to the method claimed in the CN 102,762,492 A (Method and apparatus for producing nanoparticles, 2018), an inert gas is fed to a glass tube in which there is a ceramic high-temperature heat shield, for example, provided on top of the ceramic support structure. A gasification container made of high-temperature-resistant metal or graphite is disposed within the heat shield. Outside the glass tube at the container location, an induction coil heats the gasification container. In addition to the heat shield, the cold inert air flow traveling in the tube prevents the other parts of the device from overheating. The method disclosed in the above patent application uses a holder for placing the material to be gasified, like the heat shield disposed on top of the ceramic support structure, in a way that impurities may be induced directly by the inductive heating coil or indirectly by the heating of the target material to be gasified.

In general, in a method for producing nanoparticles that uses a holder to hold the target material producing the vapor, the holder is heated together with the target material, as they are attached together, forming vapors that can mix with those of the target material, thereby contaminating the resulting particles.

Even inert materials, such as glass and ceramics, that are oftentimes employed in tube furnaces, have been shown to introduce impurities in the carrier gas and consequently to the resulting nanoparticles, comprising a main limitation for almost all applications in nanotechnology.

To avoid any possible contamination and introduction of impurities in the carrier gas and thus to obtain maximum purity of the produced nanoparticles, no other component apart from the target material has to be evaporated in the heating zone. Thus, a method avoiding placing any support or holder in the heating zone, so that only material that has to be evaporated is placed in the glass tube, is desirable.

Moreover, agglomeration of nanoparticles has to be suppressed in order to obtain a laminar aerosol nanoparticle flow.

According to the foregoing, an evaporation-condensation aerosol-based method of producing nanoparticles and based on IHNG, that overcomes the above-mentioned technical problems and that can generate nanoparticles of extremely high purity and as homogeneous as possible in shape and size, is thus highly desirable.

### SUMMARY

A specific object of the present invention is that of providing an evaporation-condensation method of producing finely dispersed aerosol nanoparticles comprising heating a target material in a localized manner for producing vapors that are subsequently cooled down to form atomic clusters and nanoparticles of extremely high purity.

According to an aspect of the present invention, a method of producing aerosol high-purity and finely dispersed nanoparticles is disclosed, said method comprising providing a glass tube comprising an inlet region, where a carrier gas is introduced, and an outlet region, through which the produced aerosol nanoparticles exit, a target material in the form of a conductive electrode, and locally heating the target material by inductive heating to produce vapors that are carried away through the carrier gas flow from the electrode in a region where they subsequently form atomic clusters, singlet and agglomerated nanoparticles.

According to the present method, the step of locally heating the target material comprises providing a coiled inductive heater surrounding concentrically the glass tube, focusing mainly the magnetic field produced by the inductive heater at a region of the target material, said region being configured, for example, in the form of an electrode tip, and determining the heating up of said region of the electrode.

According to another aspect of the present invention, a method of producing monodisperse aerosol nanoparticles of high purity level is disclosed, comprising providing a glass tube comprising an inlet region including a flow laminarizer, where a carrier gas is introduced, and an outlet region, through which the produced aerosol nanoparticles exit, a target material in the form of a conductive electrode, configured to ensure the carrier gas flow remains laminar when it goes around it, and locally heating the target material by inductive heating to produce vapor clouds that are carried away through the carrier gas flow, in a laminar way, preserving the same history as it flows further downstream, yielding particles of the same size.

According to another aspect of the present invention, a method of producing monodisperse aerosol nanoparticles of high purity level, is disclosed, wherein the formation of agglomerated nanoparticles is suppressed by diluting the vapor clouds flow immediately downstream the target electrode.

According to an embodiment of the present invention, diluting the vapor flow immediately downstream the target electrode is obtained providing specific openings in the glass tube in the region immediately downstream the target electrode, through which a diluting gas flow is introduced.

According to another embodiment of the present invention, a method of producing monodisperse aerosol nanoparticles of high purity level, is disclosed, wherein the agglomeration formation of nanoparticles is suppressed by heating up and melting the resulting agglomerated nanoparticle into spherical particles.

According to a further embodiment of the present invention, heating up and melting the resulting agglomerated nanoparticles into spherical particles is obtained by adding a second inductive heating region downstream the target electrode, said second inductive heating region having the effect of heating up the agglomerated nanoparticles.

A great advantage of the present method is that it uses materials such as glass or ceramics to confine the flow, which are not heated by induction. As these materials do not come in contact with the heated target material, the formation of impurities in the carrier gas is avoided, producing nanoparticles of extremely high purity.

Another advantage of the disclosed method for producing nanoparticles is that it can yield highly monodisperse spherical particles having sizes over a very wide range (i.e., from below 1 nm to a few microns). This can be achieved very localized emission point on the target material and maintaining flow laminarity of the carrier gas as this goes around the target material electrode, thus ensuring that the resulting vapor cloud has the same history as it flows further downstream, producing particles of the same size.

All the features of the disclosed method according to the invention are defined in the appended claims.

It must be understood that the specifications provided, on the basis of the foregoing and the following detailed descriptions and drawings, are intended to be mere examples of the invention and provide an overview to understand the nature and character of the invention as it is claimed.

### BRIEF DESCRIPTION OF THE DRAWINGS

For a better understanding of the present invention, preferred embodiments, which are intended purely by way of example and are not to be construed as limiting, will now be described with reference to the attached drawings, where:

FIG. 1 is a diagram representing in a cross-sectional side view the principle of operation of the method according to an embodiment of the present invention.

FIG. 2 is a cross-sectional side view representing how the shape of the electrode tip can ensure laminarity of the carrier gas flow as this moves around it according to an aspect of the present invention.

FIG. 3 shows graphically the nanoparticle size distribution measurements as a function of the operating flow rates (i.e., 1, 10 and 30 lpm).

FIG. 4 is a diagram representing in a cross-sectional side view the principle of operation of the method according to a second embodiment of the present invention.

FIG. 5 is a diagram representing in a cross-sectional side view the principle of operation of the method according to a third embodiment of the present invention.

### DETAILED DESCRIPTION

The following discussion is presented to enable a person skilled in the art to make and use the invention. Various modifications to the embodiments will be readily apparent to those skilled in the art, without departing from the scope of the present invention as claimed. Thus, the present invention is not intended to be limited to the embodiments described therein, but it has to be accorded the widest scope consistent with the principles and features disclosed herein and defined in the appended claims.

In conformity with the use made in the present invention the term “nanoparticles” refers to particles having a diameter of 300 nm (nanometers) or less, while “aerosol nanoparticles” refer to nanoparticles synthetized by aerosol-based technology and are thus suspended for long enough time in a gas.

In conformity with the use made in the present invention, the term “Inductive Heating” (herein referred to as IH) refers to a process, where an electrically conductive material is heated, due to the induction of eddy currents.

As used in the present invention, the term “Inductive Heating Nanoparticle Generator” (herein referred to as IHNG) refers to an apparatus for producing aerosol-nanoparticles that uses IH to evaporate materials from a conducting target electrode.

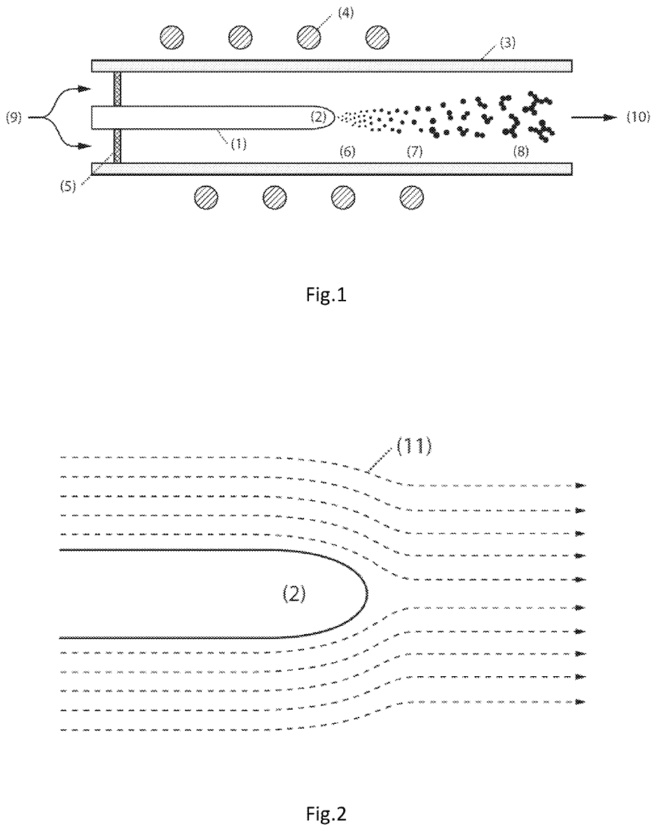

Referring to FIG. 1, the IHNG used for producing aerosol nanoparticles according to a first embodiment of the present method comprises a target material in the form of conductive electrode (1) having a tip (2) that is locally heated, a glass tube (3), a coiled inductive heater (4), a flow laminarizer (5) and a region where the vapours (6) produced by the electrodes yield atomic clusters that subsequently grow to form singlet (7) and finally agglomerated nanoparticles (8). The glass tube (3) has an inlet (9) region for the carrier gas introduction, and an outlet (10) region through which the produced nanoparticles (in the form of an aerosol) exit.

To achieve flow laminarity throughout the system, a flow laminarizer (5) is employed after the carrier gas flow inlet region (9), consisting of a device comprising a plurality of holes, and configured to allow the flow of carrier gas through it.

FIG. 1 schematically represents the principle of operation of the various steps employed in the method for synthetizing the aerosol nanoparticles according to a first embodiment.

First, a vapor is produced by a conductive target material, which has to be vaporized, by heating it up through IH. Referring to FIG. 1, the target material, which is configured in the form of an electrode (1), is housed in a glass tube (3) and is heated locally by an inductive heater (4), which comprises of a coiled tube, surrounding concentrically the glass tube (3) and the target material (1). As a result of the local heating, the target material (1) produces vapor clouds that are carried away by a pure carrier gas flow (9), which is introduced through a flow laminarizer (5) on one side of the glass tube (3), and are cooled down to produce, on the other opposite region of the glass tube (3), atomic clusters (6), singlet (7) and agglomerated (8) nanoparticles.

According to the present method, no support or holder for the target material is used, avoiding producing impurities that can contaminate the generated nanoparticles.

The fact that the target material is heated locally, attributes a unique advantage to the present method of generating nanoparticles. In fact, as only the target material (electrode) is heated up at a temperature just below its melting point, the chance to produce any impurities that may come from other materials heated beyond the target electrode, is avoided. As a result, the nanoparticles produced according to the present method are only generated from the vapours produced from the target material, attributing a high purity level to said nanoparticles.

Essential feature of the method employed according to the present invention is the local heating applied to the target material, which is achieved by configuring the IHNG apparatus in the following way:
1. configuring the target material in form of an electrode (1) with a sharp tip (2),
2. accommodating the electrode (1) tip in correspondence of the centreline of the inductive heater (4), where the magnetic field is focused and has the highest intensity,
3. avoiding using other elements in the glass tube (3) made of ferromagnetic materials.

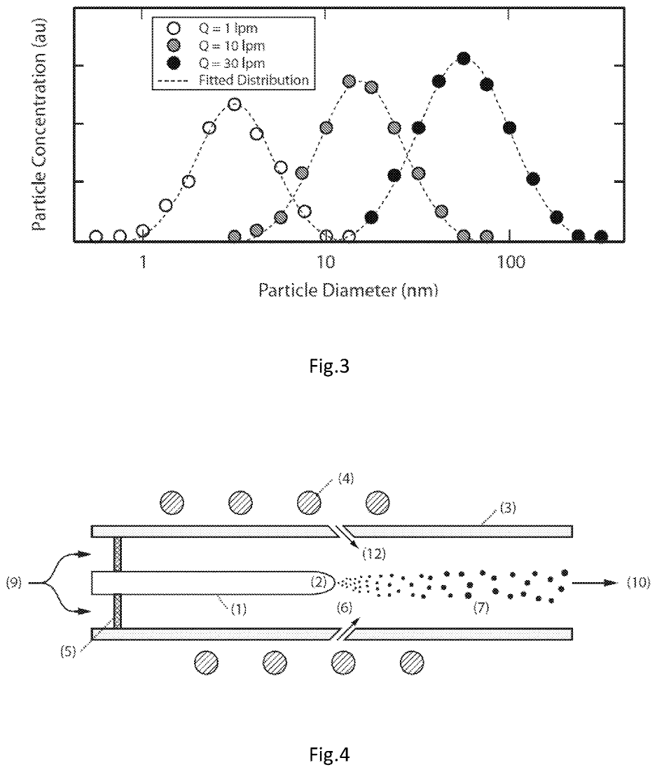

In this way the vapours produced by the heated target material have the same origin, and thus yield nanoparticles of the same size (i.e., having a rather narrow size distribution) upon natural cooling (caused by the carrier gas) as illustrated by the measurements provided in FIG. 3.

To narrow even more the particle size distributions, and thus increase the uniformity of the size (monodispersity) of the resulting particles, the tip (2) of the target electrode (1) can be shaped in a way that laminarity of the carrier gas flow going around it is ensured.

Referring to FIG. 2, according to an embodiment of the present invention, to ensure that the carrier gas flow around the electrode is laminar, and remains laminar as it approaches the electrode tip, the electrode tip (2) is shaped very smoothly in order to ensure that the carrier gas moves around it with smooth streamlines (11), avoiding any turbulences in the gas flow.

In this way highly monodisperse nanoparticles are produced as all the vapours are produced from the same point (i.e., the electrode tip) and will therefore have exactly one and the same history (depending on the residence time in the IHNG).

By varying the temperature of the target material, and the flow rate of the carrier gas, nanoparticles of different sizes can be produced. This has been demonstrated in a series of preliminary experiments showing that the mean size of the particles can vary from about 1 up to more than 100 nanometres depending on the temperature and on the carrier gas flow used. The measurements were conducted by connecting a Scanning Mobility Particle Sizer comprising of a nano-Differential Mobility Analyzer and a Condensation Particle Counter, at the outlet of the INHG.

FIG. 3 shows the results of the experiment carried out by the applicant, where three different curves are represented showing the particle concentration (expressed in arbitrary units) versus the particle diameter (expressed in nanometres) at different operating carrier gas flow rates (i.e., 1, 10 and 30 litres per minute [lpm]). The distribution of the particle concentration is shown to be log-normal, peaked in correspondence of the mean value of the distribution, which represents the particle mean diameter. As shown in FIG. 3, the mean particle diameter varies approximately from of a value of 4 nanometres up to a value of 70 nanometres in correspondence of a carrier flow rate ranging from 1 to 30 lpm.

According to another aspect of the present invention, a method of producing monodisperse aerosol nanoparticles of high purity level, is disclosed, wherein the formation of agglomerated nanoparticles is suppressed. The agglomeration of nanoparticles is in fact a typical phenomenon that is inherent to all evaporation-condensation methods producing aerosol-based nanoparticles.

A second and a third embodiments of the present method can be used with this purpose.

According to a second embodiment of the present method, the nanoparticle agglomeration can be suppressed by diluting the vapor downstream the target electrode, resulting in the formation of monodisperse singlet nanoparticles having diameters in the range from 10 to 15 nm, depending on the material used as target material.

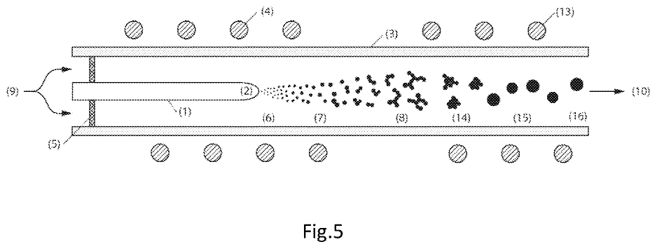

Referring to FIG. 4, a diluting carrier gas flow is introduced through specific openings (12) made in the glass tube in the region immediately downstream the target electrode tip, in this way suppressing agglomeration of nanoparticles and controlling the size of the singlet nanoparticles produced.

According to a third embodiment of the present method, and referring to FIG. 5, a first and a second inductive heater are employed, by introducing a first coil (4) surrounding concentrically the glass tube (3) in the portion of the electrode tip for producing the vapours from the target electrode, and a second coil (13), which is disposed downstream the first coil (4), for gently heating up and melting the formed agglomerated nanoparticles, forming partly restricted agglomerates (14) as well as warm (15) as subsequently cold (16) spherical solid particles upon subsequent cooling.

Finally, it is clear that numerous modifications and variants can be made to the present invention, all falling within the scope of the invention, as defined in the appended claims.

1. A method of producing high-purity and finely dispersed aerosol nanoparticles, said method consisting of the following steps:
providing a glass tube (3) comprising an inlet region (9) having a flow laminarizer (5) and an outlet region (10);
providing a coiled inductive heater (4) surrounding concentrically said glass tube (3);
providing a target material in the form of a conductive electrode (1) having an electrode tip (2), said electrode tip (2) being located in the centreline of said inductive heater (4), said centreline coinciding with the point of major intensity of the magnetic field generated by said inductive heater
introducing a carrier gas through said flow laminarizer (5) of said inlet region (9) of said glass tube (3);
local heating of said target material to a temperature closely proximate to but below its melting point by focalizing the magnetic field produced by said inductive heating (4) on said electrode tip (2) of said conductive electrode (1) to produce vapors and atomic clusters (6);
generating singlet (7) and agglomerated (8) nanoparticles by naturally cooling down said vapors and atomic clusters (6) as they are being carried by the carrier gas flow; and
expelling said singlet (7) and agglomerated nanoparticles (8) in form of an aerosol through said outlet region (10).

2. The method of producing high-purity and finely dispersed aerosol nanoparticles according to claim 1, wherein said electrode tip (2) is sharpened to ensure that the carrier gas flow is laminar and remains laminar as said carrier gas flows near said sharped electrode tip (2).

3. The method of producing high-purity and finely dispersed aerosol nanoparticles according to claim 1 wherein said singlet (7) and agglomerated (8) nanoparticles have a mean size varying from sub-nanometer dimensions to 100 nanometers.

4. The method of producing high-purity and finely dispersed aerosol nanoparticles according to claim 1 wherein any formation of agglomerated nanoparticles is suppressed, resulting in the production of monodisperse singlet nanoparticles (7) having spherical shape with diameters in the range from 10 to 15 nm.

5. The method of producing high-purity and monodisperse aerosol nanoparticles according to claim 4 further comprising the step of diluting the carrier gas flow downstream the target electrode tip (2).

6. The method of producing high-purity and monodisperse aerosol nanoparticles according to claim 5 wherein said step of diluting the carrier gas flow is implemented by further introducing carrier gas through specific openings (12) made in the glass tube in the region immediately downstream said electrode tip (2).

7. The method of producing high-purity and monodisperse aerosol nanoparticles according to claim 4 wherein said inductive heater (4) comprises a first inductive coil (4) surrounding concentrically the glass tube (3) in the region of the electrode tip (2) and a second inductive coil (13), surrounding concentrically the glass tube (3) in a region disposed downstream said first inductive coil (4), for gently heating up and melting the formed nanoparticle agglomerates and forming spherical solid particles upon natural cooling.

8. An apparatus for implementing the method according to claim 1 consisting of:
a glass tube (3) comprising an inlet region (9) having a flow laminarizer (5) and an outlet region (10);
an inductive heater (4) having at least one inductive coil surrounding concentrically said glass tube (3); and
a target material in the form of a conductive electrode (1) having an electrode tip (2), said electrode tip (2) being located in the centreline of said inductive heater (4), said centreline coinciding with the point of major intensity of the magnetic field generated by said inductive heater

9. The apparatus of claim 8 for implementing the method according to claim 4 further comprising specific openings made in the glass tube (4) in the region immediately downstream said electrode tip (2) for diluting carrier gas flow in order to suppress the formation of agglomerated nanoparticles (8).
